(19) United States
(12) Patent Application Publication
(10) Pub. No.: US 2024/0429659 A1
(43) Pub. Date: Dec. 26, 2024

(54) Grounding Member and Manufacturing Method of it, Grounding Assembly, Connector and Terminal Module

(71) Applicants: Tyco Electronics Holdings (Bermuda) No. 7 Limited, Hamilton (BM); Tyco Electronics (Shanghai) Co., Ltd., Shanghai (CN)

(72) Inventors: Hengkang Wu, Dongguan (CN); Xinjie (David) Zhang, Shanghai (CN); Ching Hsiang Chang, Taipei (TW)

(73) Assignees: Tyco Electronics Holdings (Bermuda) No. 7 Limited, Hamilton (BM); Tyco Electronics (Shanghai) Co., Ltd., Shanghai (CN)

(21) Appl. No.: 18/753,104

(22) Filed: Jun. 25, 2024

(30) Foreign Application Priority Data
Jun. 25, 2023 (CN) 202310754539.5

(51) Int. Cl. H01R 13/652; H01R 13/05; H01R 13/405; H01R 13/422; H01R 13/6581; H01R 43/16

(52) U.S. Cl. CPC H01R 13/652; H01R 13/05; H01R 13/405; H01R 13/422; H01R 13/6581; H01R 43/16

(57) ABSTRACT

A grounding member includes a plurality of contact terminals arranged in a row, a first connection strip connected to a first end of each of the contact terminals, and a second connection strip connected to a second end of each of the contact terminals. Each of the contact terminals has an elastic contact part electrically contacting one of a plurality of grounding terminals of a connector. The grounding member is an integral stamped component that interconnects the grounding terminals.

### CROSS-REFERENCE TO RELATED APPLICATION

This application claims the benefit of the filing date under 35 U.S.C. § 119 (a)-(d) of Chinese Patent Application No. 202310754539.5, filed on Jun. 25, 2023.

### FIELD OF THE INVENTION

The present invention relates to a grounding member, a method for manufacturing the grounding members, a grounding assembly including the grounding member, a terminal module comprising the grounding assembly, and a connector including the terminal module.

### BACKGROUND

In order to improve the grounding performance of connector, a grounding connection member is usually installed in the connector to electrically connect multiple grounding terminals together. However, the structure of existing grounding connection member cannot be changed according to different needs. Therefore, it is necessary to use various different manufacturing molds to manufacture grounding connection members with different structures according to different application requirements, which will lead to increased costs.

### SUMMARY

A grounding member includes a plurality of contact terminals arranged in a row, a first connection strip connected to a first end of each of the contact terminals, and a second connection strip connected to a second end of each of the contact terminals. Each of the contact terminals has an elastic contact part electrically contacting one of a plurality of grounding terminals of a connector. The grounding member is an integral stamped component that interconnects the grounding terminals.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector according to an exemplary embodiment of the present invention;

FIG. 2 shows an illustrative exploded view of a connector according to an exemplary embodiment of the present invention;

FIG. 3 shows an illustrative perspective view of a connector terminal module according to an exemplary embodiment of the present invention;

FIG. 4 shows an illustrative exploded view of a connector terminal module according to an exemplary embodiment of the present invention;

FIG. 5 shows an illustrative perspective view of a connector terminal module according to an exemplary embodiment of the present invention, wherein the upper terminal assembly has not yet been assembled with the lower terminal assembly and grounding assembly;

FIG. 6 shows an illustrative perspective view of a grounding member and a grounding member holder according to an exemplary embodiment of the present invention;

FIG. 7 shows an illustrative perspective view of a grounding member according to an exemplary embodiment of the present invention, wherein some of the multiple contact terminals are separated from each other, while others are interconnected by connection strips;

FIG. 8 shows a cross-sectional view of a connector terminal module according to an exemplary embodiment of the present invention;

FIG. 9 shows an illustrative perspective view of the upper row of terminals, lower row of terminals, and grounding member of a connector terminal module according to an exemplary embodiment of the present invention;

FIG. 10 shows an illustrative perspective view of a grounding member according to an exemplary embodiment of the present invention, wherein multiple contact terminals are interconnected by connection strips; and

FIG. 11 shows an illustrative perspective view of a grounding member according to an exemplary embodiment of the present invention, wherein multiple contact terminals are separated from each other.

### DETAILED DESCRIPTION OF EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

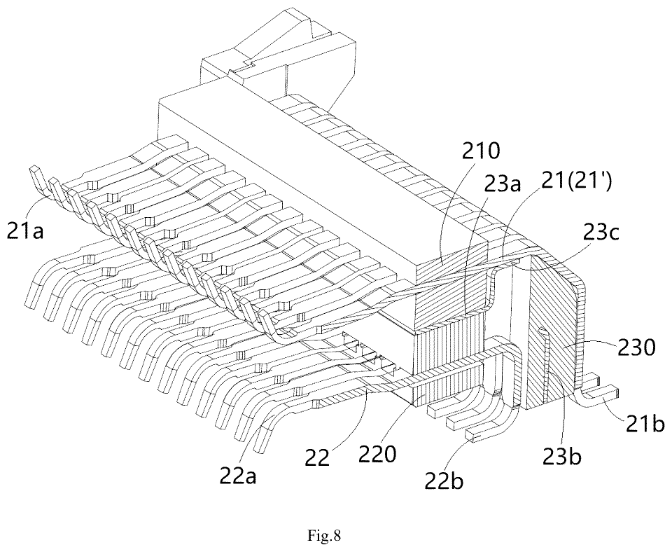

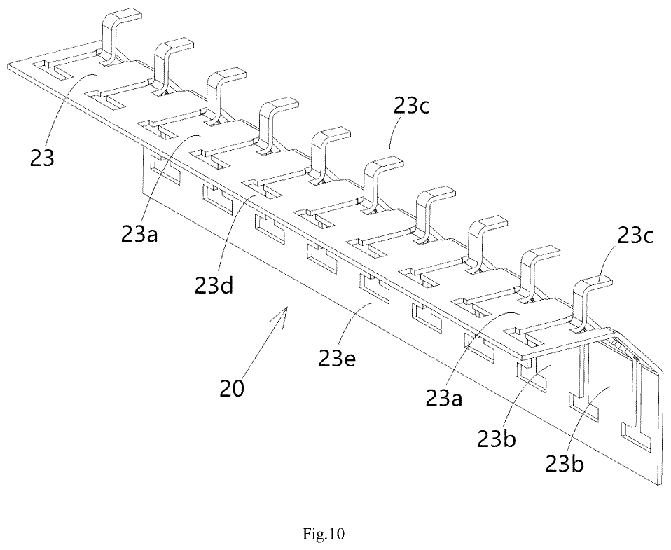

As shown in FIG. 10, in an exemplary embodiment of the present invention, a grounding member 20 is disclosed. The grounding member 20 is used for electrically connecting a plurality of grounding terminals 21′ of the connector (see FIG. 8). The grounding member 20 includes: a plurality of contact terminals 23, a first connection strip 23d, and a second connection strip 23c. The contact terminals 23 are arranged in a row. The first connection strip 23d is connected to one ends of multiple contact terminals 23. The second connection strip 23e is connected to the other ends of multiple contact terminals 23. The contact terminal 23 includes an elastic contact part 23c suitable for electrical contact with the grounding terminal 21′ of the connector, and the grounding member 20 is an integral stamped part for interconnecting multiple grounding terminals 21′ of the connector together.

As shown in FIG. 10, in the illustrated embodiment, the contact terminal 23 further includes a base plate part 23a, which is suitable for being clamped between an upper terminal holder 210 and a lower terminal holder 220 of the connector. The elastic contact part 23c is connected to the base plate part 23a and bent into a predetermined shape relative to the base plate part 23a.

As shown in FIG. 10, in the illustrated embodiment, the first connection strip 23d is connected to the ends of the base plate parts 23a of multiple contact terminals 23, so that the ends of the base plate parts 23a of multiple contact terminals 23 are interconnected by the first connection strip 23d.

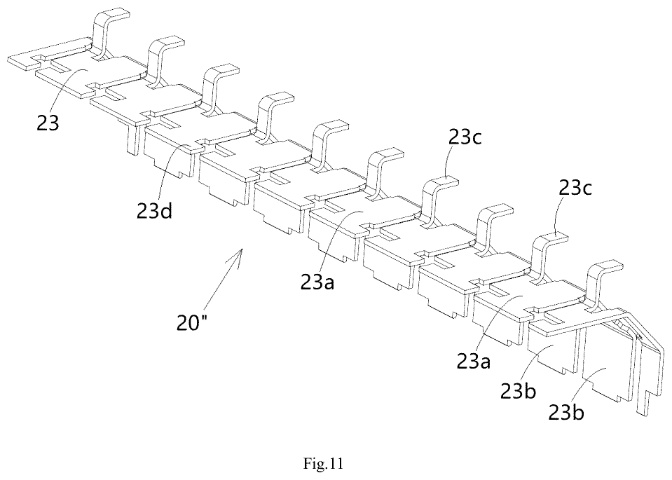

As shown in FIG. 11, in the illustrated embodiment, the contact terminal 23 further includes a fixing part 23b, which is plate-shaped and connected to the base plate part 23a. The fixing parts 23b of multiple contact terminals 23 are suitable for being fixed to the grounding member holder 230 of the connector (see FIG. 8) to fix the grounding member 20 to the grounding member holder 230.

As shown in FIG. 10, in the illustrated embodiment, the second connection strip 23e is connected to the ends of the fixing parts 23b of multiple contact terminals 23, so that the ends of the fixing parts 23b of multiple contact terminals 23 are interconnected by the second connection strip 23c.

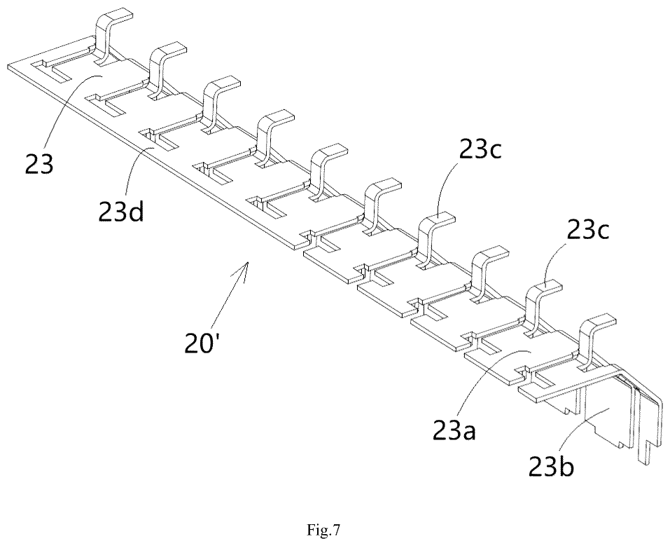

FIG. 7 shows an illustrative perspective view of a grounding member 20′ according to an exemplary embodiment of the present invention, wherein some of the multiple contact terminals 23 are separated from each other, while others are interconnected by a connection strip 23a. FIG. 11 shows an illustrative perspective view of a grounding member 20 according to an exemplary embodiment of the present invention, wherein multiple contact terminals 23 are separated from each other.

As shown in FIGS. 7 and 10-11, in another exemplary embodiment of the present invention, a method for manufacturing the grounding member is also disclosed. The method of manufacturing the grounding member includes the following steps of: providing the grounding member 20 as shown in FIG. 10; and by cutting off the entire second connection strip 23e and locally cutting off the first connection strip 23d, at least some of the multiple contact terminals 23 are separated from each other.

In this way, the grounding members with different structures can be manufactured, for example, the grounding member 20′ as shown in FIG. 7 or the grounding member 20″ as shown in FIG. 11 can be manufactured. Of course, the present invention is not limited to the illustrated embodiments, for example, the grounding members with other structures can also be manufactured according to actual needs. Therefore, in the present invention, it is only necessary to provide a manufacturing mold for the grounding member 20 shown in FIG. 10, without providing different manufacturing molds for manufacturing the grounding members 20′ and 20″ with different structures, thereby reducing the number of manufacturing molds and lowering manufacturing costs.

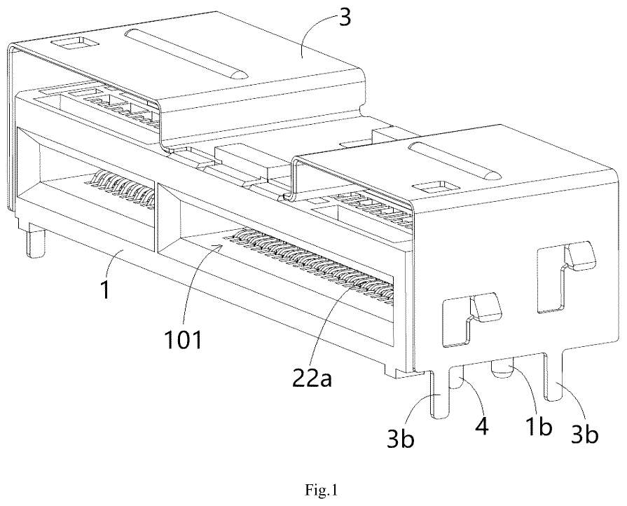

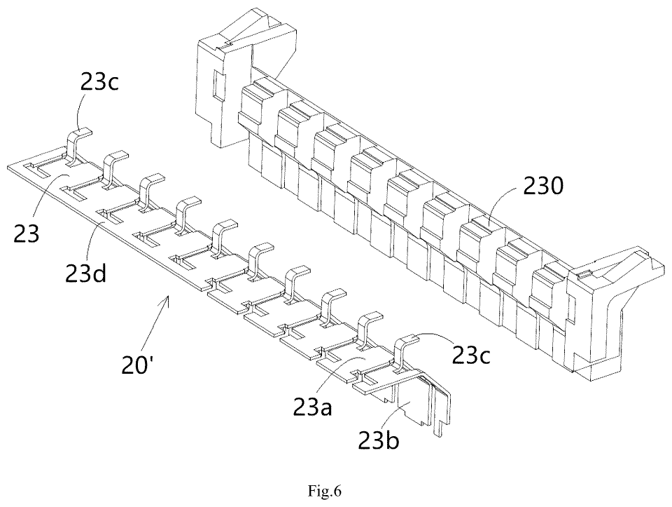

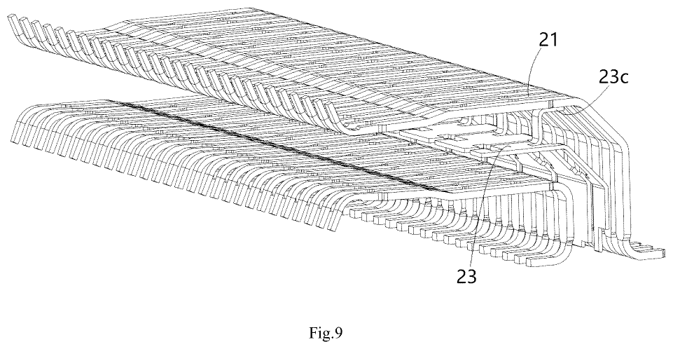

As shown in FIGS. 1 to 9, in another exemplary embodiment of the present invention, a grounding assembly is also disclosed. The grounding assembly includes: a grounding member 20′ and a grounding member holder 230. The grounding member holder 230 is used to maintain and fix the grounding member 20′. In the embodiments shown in FIGS. 1 to 9, the grounding member 20′ is manufactured by the aforementioned grounding member manufacturing method. However, the present invention is not limited to the illustrated embodiments, for example, the grounding member of the connector can also be the grounding member 20 shown in FIG. 10, the grounding member 20″ shown in FIG. 11, or other structures manufactured through the aforementioned grounding member manufacturing method.

In the illustrated embodiments, by cutting off the entire second connection strip 23e and partially cutting off the first connection strip 23d of the grounding member 20 shown in FIG. 10, some of the multiple contact terminals 23 are separated from each other. In the illustrated embodiment, some contact terminals 23 among the multiple contact terminals 23 of the grounding member 20′ are separated from each other, while others are still interconnected by the first connection strip 23d.

In the illustrated embodiments, the grounding member holder 230 is an injection molded part formed on the grounding members 20, 20′, 20″ by injection molding process, so that the grounding member holder 230 and the grounding members 20, 20′, 20″ become an integral part.

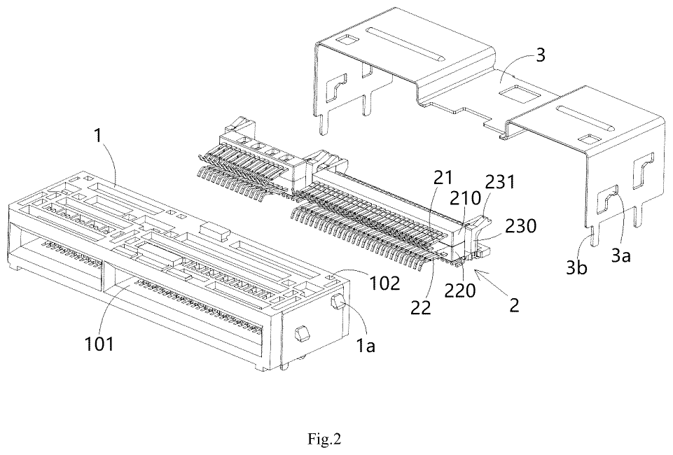

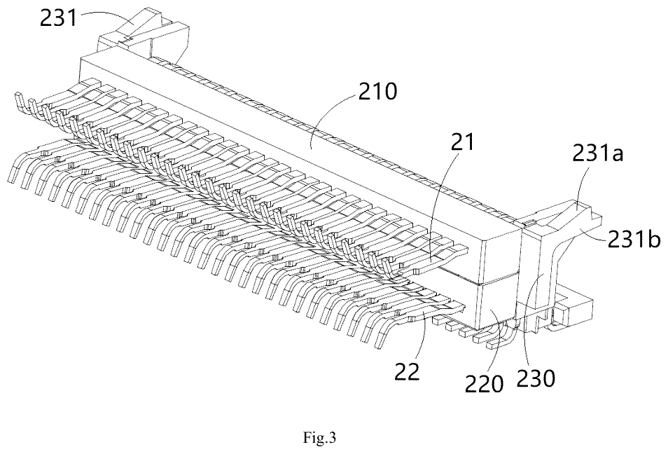

As shown in FIGS. 2 and 3, in the illustrated embodiments, an elastic buckle 231 is formed on the grounding member holder 230, which includes an elastic arm 231b and a protrusion 231a formed at the end of the elastic arm 231b. The protrusion 231a of the elastic buckle 231 is suitable for engaging with the slot 102 inside the housing 1 of the connector to lock the grounding member holder 230 into the housing 1.

As shown in FIG. 2, in another exemplary embodiment of the present invention, a connector terminal module 2 is also disclosed. The connector terminal module 2 includes: an upper terminal assembly, a lower terminal assembly, and the aforementioned grounding assembly. The upper terminal assembly includes: an upper row of terminals 21 and an upper terminal holder 210. The upper terminal holder 210 is used to hold and fix the upper row of terminals 21. The lower terminal assembly includes: a lower row of terminals 22 and a lower terminal holder 220. The lower terminal holder 220 is used to hold and fix the lower row of terminals 22. The upper terminal holder 210, lower terminal holder 220, and grounding member holder 230 are assembled together, allowing the upper terminal assembly, lower terminal assembly, and grounding assembly to be inserted together into the housing 1 of the connector.

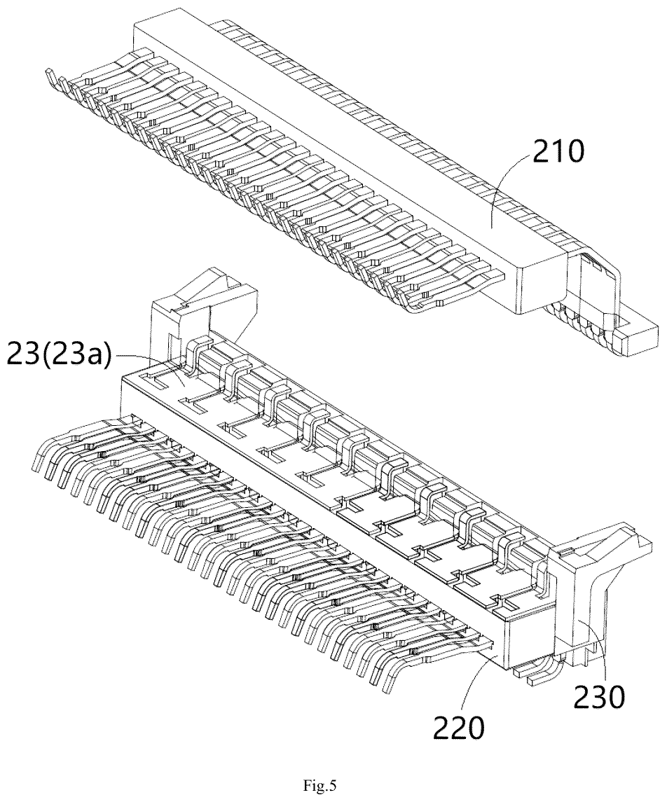

As shown in FIG. 5, in the illustrated embodiments, the base plate part 23a of the grounding members 20, 20′, 20″ is clamped between the upper terminal holder 210 and the lower terminal holder 220. The grounding member holder 230 is set between the upper row of terminals 21 and the lower row of terminals 22 to electrically isolate the upper row of terminals 21 from the lower row of terminals 22.

In the illustrated embodiments, the upper terminal holder 210 is an injection molded part formed on the upper row of terminals 21 by injection molding process, so that the upper terminal holder 210 and the upper row of terminals 21 become an integral part. The lower terminal holder 220 is an injection molded part formed on the lower row of terminals 22 by injection molding process, so that the lower terminal holder 220 and the lower row of terminals 22 become an integral part.

As shown in FIG. 8, in the illustrated embodiments, the upper row of terminals 21 includes multiple grounding terminals 21′, and the elastic contact parts 23c of the multiple contact terminals 23 of the grounding members 20, 20′, 20″ are in electrical contact with the multiple grounding terminals 21′ of the upper row of terminals 21.

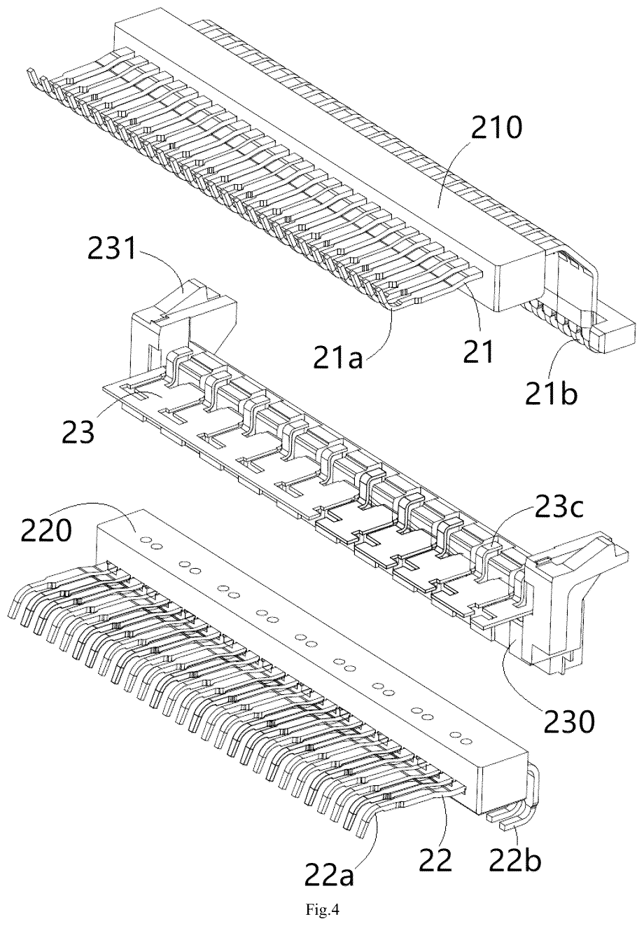

As shown in FIGS. 4 and 8, in the illustrated embodiments, the upper row of terminals 21 each has a first elastic arm 21a and a first connecting leg 21b that extend from the front and rear sides of the upper terminal holder 210, respectively. The lower row of terminals 22 each has a second elastic arm 22a and a second connecting leg 22b that extend from the front and rear sides of the lower terminal holder 220, respectively. The first elastic arm 21a and the second elastic arm 22a are used for electrical contact with a board card of a mating connector inserted into an insertion slot 101 of a housing 1 of a connector, and the first connecting leg 21b and the second connecting leg 22b are used for electrical connection to the circuit board.

As shown in FIGS. 5 and 8, in the illustrated embodiments, the grounding member holder 230 is provided behind the upper terminal holder 210 and the lower terminal holder 220, and is located between the first connecting legs 21b of the upper row of terminals 21 and the second connecting legs 22b of the lower row of terminals 22 to electrically isolate the first connecting legs 21b of the upper row of terminals 21 from the second connecting legs 22b of the lower row of terminals 22.

In another exemplary embodiment of the present invention, a connector is also disclosed. The connector includes: a housing 1 and the aforementioned connector terminal module 2, and the connector terminal module 2 is installed in housing 1.

As shown in FIGS. 1 and 2, in the illustrated embodiments, an insertion slot 101 is formed in the front side of the housing 1 for mating with a board card of the mating connector. The first elastic arms 21a of the upper row of terminals 21 and the second elastic arms 22a of the lower row of terminals 22 extend into insertion slot 101 of the housing 1 for electrical contact with the board card inserted into insertion slot 101.

As shown in FIGS. 1 and 2, in the illustrated embodiments, the connector further comprises a shielding shell 3, which is installed on the outside of the housing 1, and a slot hole 3a is formed in the side wall of the shielding shell 3, and a protrusion part 1a is formed on the side wall of the housing 1. The protrusion part 1a is engaged with the slot hole 3a to fix the shielding shell 3 to the housing 1.

As shown in FIGS. 1 and 2, in the illustrated embodiments, a connecting part 3b is formed at the bottom of the shielding shell 3, which is suitable for inserting into a hole formed in a circuit board, to fix and electrically connect the shielding shell 3 to the circuit board. A positioning post 1b is formed at the bottom of housing 1, which is suitable for insertion into a positioning hole formed in the circuit board.

As shown in FIG. 1, in the illustrated embodiments, the connector further comprises a mounting component 4, which is fixed to the housing 1 and is adapted to be connected to the circuit board, for fixing the housing 1 to the circuit board.

In the aforementioned exemplary embodiments of the present invention, the structure of the grounding member can be changed by cutting the connection strip of the grounding member, so that the structure of the grounding member can be changed according to different needs. Therefore, the present invention does not require providing multiple different manufacturing molds, reducing manufacturing costs.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A grounding member, comprising:
a plurality of contact terminals arranged in a row;
a first connection strip connected to a first end of each of the contact terminals; and
a second connection strip connected to a second end of each of the contact terminals, each of the contact terminals has an elastic contact part electrically contacting one of a plurality of grounding terminals of a connector, the grounding member is an integral stamped component that interconnects the grounding terminals.

2. The grounding member of claim 1, wherein each of the contact terminals has a base plate part clamped between an upper terminal holder and a lower terminal holder of the connector, the elastic contact part is connected to the base plate part and bent into a predetermined shape relative to the base plate part.

3. The grounding member of claim 2, wherein the first connection strip is connected to an end of the base plate part of each of the contact terminals.

4. The grounding member of claim 2, wherein each of the contact terminals has a fixing part that is plate-shaped and connected to the base plate part, the fixing parts of the contact terminals are fixed in a grounding member holder of the connector to fix the grounding member to the grounding member holder.

5. The grounding member of claim 4, wherein the second connection strip is connected to an end of the fixing part of each of the contact terminals.

6. A method for manufacturing a grounding member, comprising:
providing a first grounding member including a plurality of contact terminals arranged in a row, a first connection strip connected to a first end of each of the contact terminals, and a second connection strip connected to a second end of each of the contact terminals, each of the contact terminals has an elastic contact part electrically contacting one of a plurality of grounding terminals of a connector, the first grounding member is an integral stamped component that interconnects the grounding terminals;
cutting off the second connection strip; and
locally cutting off the first connection strip, at least some of the contact terminals are separated from each other to obtain a second grounding member with a structure different from the first grounding member.

7. A grounding assembly, comprising:
a grounding member including a plurality of contact terminals arranged in a row, a first connection strip connected to a first end of each of the contact terminals, and a second connection strip connected to a second end of each of the contact terminals, each of the contact terminals has an elastic contact part electrically contacting one of a plurality of grounding terminals of a connector, the grounding member is an integral stamped component that interconnects the grounding terminals; and
a grounding member holder that holds and fixes the grounding member.

8. The grounding assembly of claim 7, wherein a first set of the contact terminals are separated from each other and a second set of the contact terminals are not separated from each other.

9. The grounding assembly of claim 7, wherein the contact terminals are all separated from each other.

10. The grounding assembly of claim 7, wherein the grounding member holder is an injection molded part formed on the grounding member by an injection molding process, the grounding member holder and the grounding member are formed into an integral part.

11. The grounding assembly of claim 7, wherein the grounding member holder has an elastic buckle that includes an elastic arm and a protrusion on an end of the elastic arm, the protrusion engages a slot inside a housing of the connector to lock the grounding member holder in the housing.

12. A connector terminal module, comprising:
an upper terminal assembly including an upper row of terminals and an upper terminal holder that holds and fixes the upper row of terminals;
a lower terminal assembly including a lower row of terminals and a lower terminal holder that holds and fixes the lower row of terminals; and
a grounding assembly including a grounding member and a grounding member holder that holds and fixes the grounding member, the grounding member includes a plurality of contact terminals arranged in a row, a first connection strip connected to a first end of each of the contact terminals, and a second connection strip connected to a second end of each of the contact terminals, each of the contact terminals has an elastic contact part electrically contacting one of a plurality of grounding terminals of a connector, the grounding member is an integral stamped component that interconnects the grounding terminals, the upper terminal holder, the lower terminal holder, and the grounding member holder are assembled together, the upper terminal assembly, the lower terminal assembly, and the grounding assembly are insertable together into a housing of the connector.

13. The connector terminal module of claim 12, wherein a base plate part of the grounding member is clamped between the upper terminal holder and the lower terminal holder, the grounding member holder is disposed between the upper row of terminals and the lower row of terminals to electrically isolate the upper row of terminals from the lower row of terminals.

14. The connector terminal module of claim 12, wherein the upper terminal holder is an injection molded part formed on the upper row of terminals, the upper terminal holder and the upper row of terminals are formed into an integral part, the lower terminal holder is an injection molded part formed on the lower row of terminals, the lower terminal holder and the lower row of terminals are formed into an integral part.

15. The connector terminal module of claim 12, wherein the upper row of terminals has the grounding terminals.

16. The connector terminal module of claim 12, wherein the upper row of terminals each has a first elastic arm extending from a front side of the upper terminal holder and a first connecting leg extending from a rear side of the upper terminal holder, the lower row of terminals each has a second elastic arm extending from a front side of the lower terminal holder and a second connecting leg extending from a rear side of the lower terminal holder, the first elastic arm and the second elastic arm electrically contact a board card of a mating connector inserted into an insertion slot of the housing, the first connecting leg and the second connecting leg electrically connect to a circuit board.

17. The connector terminal module of claim 16, wherein the grounding member holder is provided at a rear of the upper terminal holder and the lower terminal holder and is located between the first connecting legs of the upper row of terminals and the second connecting legs of the lower row of terminals to electrically isolate the first connecting legs from the second connecting legs.

18. A connector, comprising:
a housing; and
a connector terminal module installed in the housing, the connector terminal module including:
an upper terminal assembly including an upper row of terminals and an upper terminal holder that holds and fixes the upper row of terminals;
a lower terminal assembly including a lower row of terminals and a lower terminal holder that holds and fixes the lower row of terminals; and
a grounding assembly including a grounding member and a grounding member holder that holds and fixes the grounding member, the grounding member includes a plurality of contact terminals arranged in a row, a first connection strip connected to a first end of each of the contact terminals, and a second connection strip connected to a second end of each of the contact terminals, each of the contact terminals has an elastic contact part electrically contacting one of a plurality of grounding terminals of a connector, the grounding member is an integral stamped component that interconnects the grounding terminals, the upper terminal holder, the lower terminal holder, and the grounding member holder are assembled together, the upper terminal assembly, the lower terminal assembly, and the grounding assembly are insertable together into the housing.

19. The connector of claim 18, wherein the housing has an insertion slot on a front side for mating with a board card of a mating connector, a plurality of first elastic arms of the upper row of terminals and a plurality of second elastic arms of the lower row of terminals extend into the insertion slot of the housing to electrically contact the board card.

20. The connector of claim 18, further comprising a shielding shell installed on an outside of the housing, the shielding shell has a slot hole on a side wall, a protrusion part is formed on the side wall, the protrusion part engages the slot hole to fix the shielding shell to the housing.

21. The connector of claim 20, wherein a bottom of the shielding shell has a connecting part insertable into a hole in a circuit board to fix and electrically connect the shielding shell to the circuit board, a positioning post insertable into a positioning hole in the circuit board is formed at a bottom of the housing.

22. The connector of claim 21, further comprising a mounting component fixed into the housing and connectable to the circuit board, to fix the housing to the circuit board.
